(19) United States
(12) Patent Application Publication
(10) Pub. No.: US 2004/0208410 A1
(43) Pub. Date: Oct. 21, 2004

(54) Bearing device, head support device and recording/reproducing device

(76) Inventor: Hideki Kuwajima, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/791,885

(22) Filed: Mar. 4, 2004

(30) Foreign Application Priority Data
Mar. 7, 2003 (JP) 2003-062251

(51) Int. Cl. F16C 33/38; F16C 33/60

(52) U.S. Cl. 384/504; 384/523

(57) ABSTRACT

The object of the present invention is to provide a bearing device, a head support device, and a magnetic recording/reproducing device which can be used in a HDD or the like for a long period of time and are able to meet the purposes such as size reduction, high performance, low noise, high speed, and low cost.

The first retainer comprises a plurality of grooves 211, 212 and 213 at one end of rotary axis 210 of retainer 200. The second retainer comprises a plurality of grooves 221, 222 at the other end of retainer 200. It is configured in that grooves disposed in the first retainer and the second retainer are not positioned at the same outer periphery of the retainer 200 so that the groove 222 of the second retainer is positioned between groove 211 and groove 212 of the first retainer.

### FIELD OF THE INVENTION

The present invention relates to a bearing device, a head support device, and a recording/reproducing device, and more particularly, it relates to a bearing device, a head support device, and a recording/reproducing device using these devices, capable of reducing the rotational load of ball bearings during high-speed rotation as in HDD actuator, preventing damage to the ball bearings and noise due to uneven rotation, and further, realizing cost reduction.

### BACKGROUND OF THE INVENTION

Regarding an actuator used in hard disk drive (HDD), for example, it is disclosed in Japanese Patent No. 2539180. In FIG. 2 of the disclosure is shown an actuator assembly in HDD, wherein a magnetic disk is mounted on a spindle motor for rotating the disk. According to the actuator assembly, an arm having a magnetic head at the end thereof is rotated by an actuator using a voice coil motor (hereafter called VCM), and the position of the magnetic head is controlled on the magnetic head, enabling read and write of magnetic information, as is described in the disclosure.

Also, in FIG. 1 of the Japanese Patent No. 2539180 is shown a pivot bearing, wherein a pair of roll bearings are arranged apart from each other in an axial direction. Further, a pre-load is given between the bearings by using a coil spring, that is, a pre-loading means.

Also, disclosed in Japanese Patent Laid-Open Application H9-103045 is a bearing device wherein a retainer is disposed, that is, the bearing are provided with three balls arranged 120 deg apart at equal intervals. In the case of a bearing device having such a configuration, three balls come in contact with a thrust washer without fail, and as claimed in the disclosure, it is possible to suppress the generation of noise even in case the thrust washer is rather poor in flatness or has a rough.

However, in a hard disk drive, as disclosed in Japanese Patent No. 2539180 mentioned above, there are increasing demands for a higher speed, smaller size, lower power consumption, and larger capacity. Also, as for a pivot bearing, it is necessary to lower the starting torque because of repetition of its start and stop. Further, the starting torque is determined by the pre-load or the like applied to the pivot bearing, and higher starting torque is required when the pre-load is higher. The pre-load applied to the pivot bearing is required to be higher than the specified level in order to make the balls come in contact with the inner ring and outer ring of the bearing, but it is better to be as low as possible. This is because the elastic deformation of the ball can be suppressed when the pre-load applied is lower.

The present invention is intended to provide a bearing device which may assure radially sufficient shaft rigidity even in case of a low pre-load, and the object of the invention is to realize a head support device having excellent features such as low noise, higher speed, extra-long life, and low cost.

### SUMMARY OF THE INVENTION

The bearing device of the present invention comprises a first bearing and a second bearing. The first bearing and the second bearing are arranged one upon another in the axial direction of the bearing device. The first bearing has a first retainer, and a plurality of first grooves are provided at the outer periphery of the first retainer. The second bearing has a second retainer, and a plurality of second grooves are provided at the outer periphery of the second retainer. The bearing device is configured in that balls are placed in the first grooves and the second grooves in such manner that the first segment connecting the center of the first retainer to the first groove does not overlap the second segment connecting the center of the second retainer to the second groove.

Thus, the first bearing and the second bearing are arranged in the radial direction of the retainer, and also, the ball in the first retainer and the ball in the second retainer are arranged in positions axially different from each other, and therefore, axial deviation hardly takes place and it is possible to reduce the generation of noise.

Further, since the bearing uses three balls, it is not required to add great elastic deformation to the balls. Accordingly, the pre-load of the bearing can be lowered, and consequently, the starting torque can be lowered and it is possible to realize a bearing of high-speed response and power-saving.

Also, the bearing device of the present invention comprises a first bearing and a second bearing. The first bearing and the second bearing are arranged one upon another in the axial direction of the bearing device. The first bearing has a first retainer, and a plurality of first grooves are provided at the outer periphery of the first retainer. The second bearing has a second retainer, and a plurality of second grooves are provided at the outer periphery of the second retainer. The bearing device is configured in that balls are placed in the first grooves and the second grooves in such manner that the first segment connecting the center of the first retainer to the first groove does not overlap the second segment connecting the center of the second retainer to the second groove, which is provided with an inner sleeve supporting the inner ring for the balls of the first bearing and the second bearing, and an outer sleeve supporting the outer ring for the balls of the first bearing and the second bearing.

Thus, it is possible to decrease the number of balls and to reduce the elastic deformation load of the ball bearing. Also, the first bearing and the second bearing are arranged in the radial direction of the retainer, and also, the ball in the first retainer and the ball in the second retainer are arranged in positions axially different from each other, and therefore, axial deviation hardly takes place and it is possible to reduce the generation of noise.

Moreover, since the number of bearings can be lessened, the diameter of the bearing can be reduced, and also, since the pre-load can be lowered, the starting torque can be lowered, and it is possible to realize a bearing device of high-speed response and power-saving.

Further, the head support device of the present invention is a head support device wherein the first bearing and the second bearing are arranged one upon another in the axial direction of the bearing device. The first bearing has a first retainer, and a plurality of first grooves are provided at the outer periphery of the first retainer. The second bearing has a second retainer, and a plurality of second grooves are provided at the outer periphery of the second retainer. Balls are placed in the first grooves and the second grooves in such manner that the first segment connecting the center of the first retainer to the first groove does not overlap the second segment connecting the center of the second groove, and the bearing device is connected to a support arm having a slider and a voice coil.

Thus, the bearing for rotationally supporting the arm of the head support device can be reduced in size, and also, the pre-load applied to the ball can be lessened. Accordingly, it is possible to realize a head support device having a support arm, which is small-sized, excellent in rotational response, and low noise.

Further, the recording/reproducing device of the present invention comprises a recording medium and a rotation driving means for rotationally driving the recording medium, a support arm mounted with a slider and a voice coil, which has a head for reading information stored in the recording medium, and a head support device for driving the support arm. The head support device comprises a bearing device provided with a first bearing and a second bearing. The first bearing and the second bearing are arranged one upon another in the axial direction of the bearing device. The first bearing has a first retainer, and a plurality of first grooves are provided at the outer periphery of the first retainer. The second bearing has a second retainer, and a plurality of second grooves are provided at the outer periphery of the second retainer. Balls are placed in the first grooves and the second grooves in such manner that a first segment connecting the center of the first retainer to the first groove does not overlap a second segment connecting the center of the second retainer to the second groove, and the bearing device is connected to a support arm having a slider and a voice coil.

Thus, the device can be applied to a small recording medium and it is possible to realize a recording/reproducing device of high performance and low cost, which has excellent features such as being small-sized and light-weight, high-speed response, and low noise.

### BRIEF DESCRIPTION OF THE DRAWINGS

FIG. 1 is a perspective view of a recording/reproducing device in one exemplary embodiment of the present invention.

FIG. 2 is a schematic diagram of a head support device in one exemplary embodiment of the present invention.

FIG. 3 is a schematic sectional view of a bearing device in one exemplary embodiment of the present invention.

FIG. 4 is an A-A′ sectional view of the bearing device shown in FIG. 3 in one exemplary embodiment of the present invention.

FIG. 5 is a perspective view of a retainer that is a main component of the bearing device in one exemplary embodiment of the present invention.

FIG. 6 is a diagram of assembling the inner ring sleeve and outer ring sleeve of a bearing to a retainer in one exemplary embodiment of the present invention.

### DETAILED DESCRIPTION OF THE EXEMPLARY EMBODIMENT

The exemplary embodiments of the present invention will be described in the following with reference to the drawings.

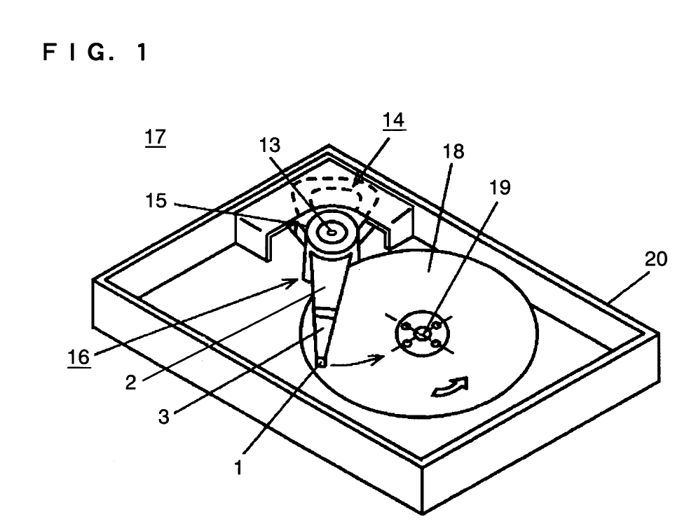

FIG. 1 is a perspective view of a general configuration of a recording/reproducing device in one exemplary embodiment of the present invention. In FIG. 1, head support device 16 is formed of suspension 3, slider 1 at the end of the suspension 3, support arm 2, and bearing device 15, which is supported so as to be rotatable about the rotary shaft 13 of the bearing device 15.

At the head support device 16, there is provided driving means 14 such as VCM fitted on the support arm 2 at a position axisymmetrically apart from the slider 1 with the bearing device 15 therebetween. The driving means 14 such as a voice coil is supplied with a drive control current for the purpose of driving, and thereby, the head support device 16 is rotationally moved at a specified angle for tracking a magnetic head (not shown) or the like mounted on the slider 1 to a specified position of recording medium 18. As the driving means 14, for example, VCM or a linear motor can be used.

On the other hand, the recording medium 18 is rotated at a specified speed by rotation driving means 19. As the rotation driving means 19, for example, spindle motor 127 can be used. Casing 20 houses the head support device 16, bearing device 15, driving device 14 such as a voice coil, recording medium 18, and rotation driving means 19 in their specified positions, and encloses them with a cover (not shown) to configure a recording/reproducing device 17. The casing 20 together with the cover serves to protect the recording/reproducing means 17 and to prevent the recording medium 18 and the head from deterioration due to external corrosive gas or dust.

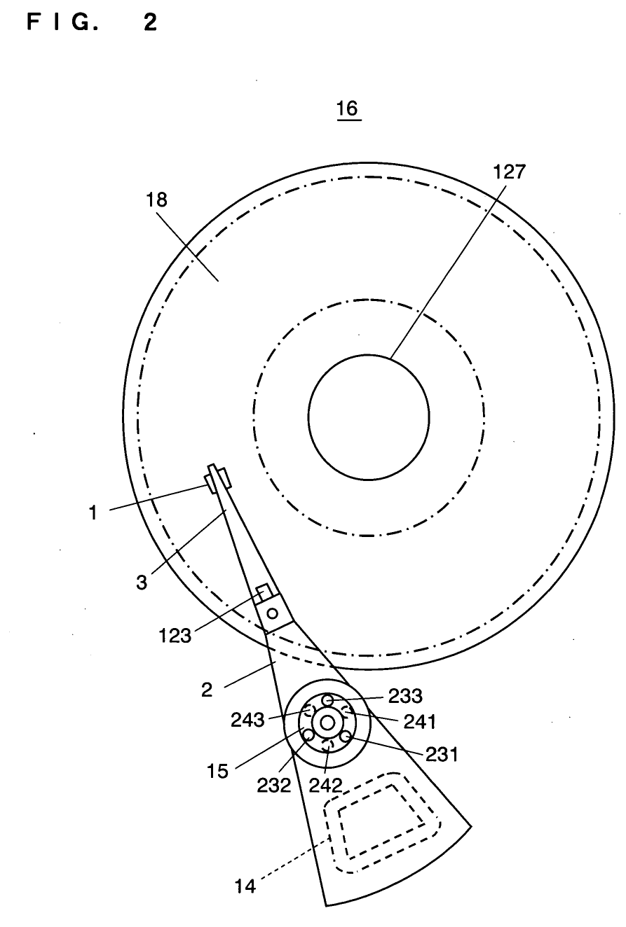

FIG. 2 shows an example of a head support device in one exemplary embodiment of the present invention, which rotationally moves the head radially on a recording medium by means of VCM in particular and is widely employed for small-sized HDD. In FIG. 2, the head support device 16 is mainly formed of the bearing device 15 and the support arm 2 having the driving device 14 such as slider 1 and a voice coil.

The head support device 16 comprises the suspension 3 of relatively low rigidity, plate spring 123, and support arm 2 of relatively high rigidity, and on the underside at one end of the suspension 3 is disposed the slider 1 mounted with a magnetic head (not shown).

Also, the recording medium 18 using magnetism is rotated by a rotation driving means such as a spindle motor. During the recording/reproducing operation of the recording/reproducing device 17 using magnetism, from the balancing relationship between the floating force applied to the slider 1 due to the air flow generated by the rotation of the recording medium 18 using magnetism and the activating force applied by the plate spring 123 of the head support device 16 to activate the slider toward the recording medium 18 using magnetism or the like, the slider 1 floats by a fixed amount from the recording medium 18 using magnetism or the like, that is, a head such as a magnetic head mounted on the slider floats by a fixed amount from the recording medium 18 using magnetism or the like.

In the recording or reproducing mode of the recording/reproducing device 17 using magnetism, the head support device 16 is rotated about the bearing device 15 by the action of the driving device 14 such as a voice coil disposed at the back of the support arm 2. A head using a magnet or the like mounted on the slider 1 is tracked to a specified position of the recording medium 18 for executing the recording or reproducing operation.

Also, the driving device 14 such as a voice coil is disposed at the opposite end of the support arm 2 as against the slider 1 mounted with a head (not shown) such as a magnetic head, thereby configuring a VCM for rotationally driving the head mounted on the slider 1 radially of the recording medium 18. There are many proposals with respect to the VCM which is a component element of the head support device 16 for accurately positioning at a high speed.

In FIG. 1 and FIG. 2, a magnetic medium of HDD or the like and a magnetic head are respectively used for the description of the recording medium 18 and the head, but the present invention is not limited to this configuration. For example, a similar configuration can be realized by using an optical disk as the recording medium 18 and an optical head as the head.

The bearing device 15 is configured in that balls 231, 231 and 233 shown by solid line are arranged at one end of a retainer described later, while balls 241, 242 and 243 shown by broken line are arranged at the other end of the retainer described later. The embodiments will be described in the following.

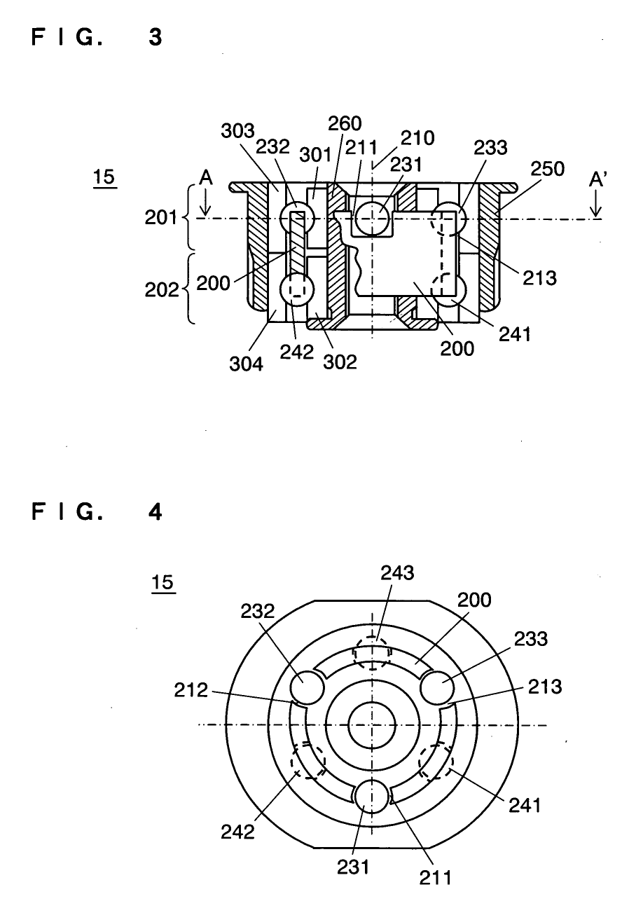

FIG. 3 is a schematic sectional view of one embodiment showing a detailed configuration of bearing device 15 on the exemplary embodiment 3 of the present invention.

FIG. 4 is an A-A′ sectional view of the bearing device of FIG. 3.

The bearing device 15 of the present invention uses a ball bearing and comprises a first bearing section 201 and a second bearing section 202. The first bearing section 201 and the second bearing section 202 are arranged one upon another along the rotary axis 210 of the bearing device 15. The first bearing section 201 includes one end (first retainer) of retainer 200. One end (first retainer) of the retainer 200 is provided with a plurality of grooves 211, 212 and 213 disposed at the outer periphery on a radial line from the rotary axis 210, that is, at the outer periphery in a radial direction of the retainer 200. The second bearing section 202 includes the other end (second retainer) of the retainer 200. The other end (second retainer) of the retainer 200 is provided with a plurality of grooves 221, 222 and 223 disposed at the outer periphery of the other end of the retainer. The grooves 211, 212 and 213 are arranged 120 degrees apart from each other.

Similarly, the grooves 221, 222 and 223 are arranged 120 degrees apart from each other. The grooves 211, 212 and 213 disposed at one end (first retainer) of the retainer 200 and the grooves 221, 222 and 223 disposed at the other end (second retainer) of the retainer 200 are respectively arranged at the outer peripheries extending radially from the rotary axis 210, that is, at the outer peripheries of the retainer 200. The grooves 211, 212 and 213, and the grooves 221, 222 and 223 disposed at the other end (second retainer) of the retainer 200 are respectively arranged at the peripheries thereof with an angular difference of 60 degrees each in the radial direction of the retainer 200.

Balls 231, 232 and 233 are respectively placed in the grooves 211, 212 and 213 arranged at one end (first retainer) of the retainer 200. Balls 241, 242 and 243 are respectively placed in the grooves 221, 222 and 223 arranged at the other end (second retainer) of the retainer 200. In the present embodiment, one end (first retainer) of the retainer 200 and the other end (second retainer) of the retainer 200 are formed in one shell. However, it is also preferable to form one end (first retainer) of the retainer 200 and the other end (second retainer) of the retainer 200 by using separate shells and to integrate them by means of bonding agent or connecting jig.

Inner rings 301, 302 are fixed on inner sleeve 260, which have guide grooves for regulating the inner sides of the balls 231, 232 and 233 of the first retainer, and the balls 241, 242 and 243 of the second retainer. Outer rings 303, 304 are fixed on outer sleeve 250, which have guide grooves for regulating the outer sides of the balls 231, 232 and 233, and the balls 241, 242 and 243. The inner rings 301, 302 and the outer rings 303, 304 rotate relatively in opposite directions about the rotary axis 210 via the balls 231, 232, 233 and the balls 241, 242, 243.

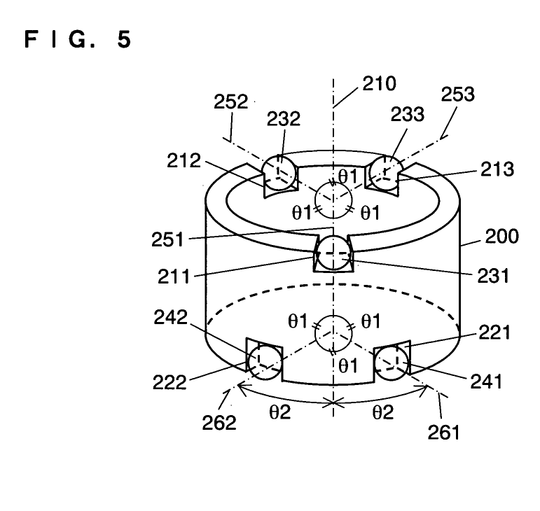

FIG. 5 shows the retainer 200 in one embodiment of the present invention. The retainer 200 shown in FIG. 5 is nearly cylindrical with a plurality of grooves formed at the outer peripheries thereof. The first retainer is formed at one end of rotary axis 210 of the retainer 200. The second retainer is formed at the opposite side of the first retainer or at the other end of the retainer 200.

In one embodiment of the present invention, one shell is used for the first retainer and the second retainer, that is, a single unit (one shell) is used for the retainers, but the present embodiment is not limited to this configuration. Namely, it is preferable to form the first retainer and the second retainer separately and to structurally integrate them by means of boding agent or connecting jig. FIG. 5 shows the first retainer and the second retainer originally formed by using one shell.

A plurality of grooves 211, 212 and 213 are arranged at the outer periphery in the radial direction of the retainer 200, that is, at the upper side in normal vision of FIG. 5 of the first retainer of the retainer 200. The intervals between the grooves 211 and 212 and between the grooves 212 and 213, that is, the disposition angle is shown by θ1. Also, the grooves 211, 212 and 213 are disposed at the outer periphery of the retainer 200, equal disposition angle θ1=120 degrees apart from each other respectively on segments 251, 252 and 253 radially extending from the center of the retainer 200, that is, from the rotary axis 210.

Also, in normal vision of FIG. 5, the second retainer is disposed at the bottom or the other end of the retainer 200. A plurality of grooves 221, 222 and 223 of the second retainer are disposed at a part of the outer periphery in the radial direction of the retainer 200 the same as in disposing the grooves of the first retainer. The plurality of grooves 221, 222 and 223 (223 is not shown in FIG. 5) are respectively disposed on segments 261, 262 and 263 (segment 263 is not shown in FIG. 5), and their disposition angles θ1 are identical.

That is, to summarize the features of the present invention, the first segment (251, 252, 253) connecting the center of the first retainer to the first groove does not overlap the second segment (261, 262, 263) connecting the center of the second retainer to the second groove. Namely, balls are respectively placed in the first groove and the second groove.

In addition, it is arranged so that the segment 262 at the second retainer side is positioned between the segments 251 and 252 at the first retainer side.

For the convenience of plotting, the second retainer shown has two grooves 221 and 222, but you are requested to understand that the retainer actually has three grooves the same as in the first retainer. Also, the intervals between the grooves 221 and 222, the grooves 222 and 223, the grooves 223 and 221 are equal to each other, that is, θ1=120 degrees.

The grooves 211, 212 and 213 disposed at one end (first retainer) of the retainer 200, and the grooves 221, 222 and 223 disposed at the other end (second retainer) of the retainer 200 are arranged angle θ2 apart from each other in the radial direction of the retainer 200. Here, the angle is set to θ2=60 degrees. In other words, the groove of the second retainer does not exist on a line extended from the center of the groove disposed in the first retainer downward in parallel with the rotary axis 210 toward the second retainer side. Naturally, the groove of the first retainer does not exist. on the extended from the center of the groove disposed in the second retainer toward the first retainer side in parallel with the rotary axis 210. It can considered that the groove of the first retainer and the groove of the second retainer are arranged in zigzag form with respect to their positions.

Also, θ2=60 degrees signifies that the groove of the second retainer is positioned between the grooves of the first retainer. The balls 231, 232 and 233 are respectively placed in the grooves 211, 212 and 213 disposed at one end (first retainer) of the retainer 200 having such a structure. The balls 241, 242 and 243 are respectively placed in the grooves 221, 222 and 223 disposed at the other end (second retainer) of the retainer 200.

Usually, when the number of grooves disposed at one end (first retainer) in the segmental direction of rotary axis 210 of the retainer 200 and at the other end (second retainer) thereof is N (N is 2 or larger integer) respectively, the disposition angle of a plurality of grooves to each other which are disposed at one end (first retainer) of the retainer 200 is θ1=360/N (degrees). Similarly, the disposition angle of a plurality of grooves to each other which are disposed at the other end (second retainer) of the retainer 200 is θ1=360/N (degrees).

Also, the groove at one end (first retainer) of the retainer 200 and the groove at the other end (second retainer) of the retainer 200 are preferable to be apart from each other at angle θ2=360 (2N) degrees.

As to the angle θ2, it is not always necessary to set the groove at the other end (second retainer) to the disposition angle=360/(2N) degrees in the radial direction of the retainer 200. That is, it is only required to avoid θ2=0 degree or disposing the grooves 211 to 213 of the first retainer and the grooves 221 to 223 of the second retainer on the same segment. For example, θ2 is preferable to be either 10 degrees and 20 degrees. The angle θ2 must be properly determined in accordance with the result of experiment with respect to conditions such as the length of retainer in the direction of rotary axis, outer diameter, number of grooves, rotational direction and angle to the bearing.

The figure is developed along the outer periphery of the retainer 200. The grooves disposed in zigzag fashion at one end and the other end of the retainer form a stable triangle between them. Thus, it is possible to stabilize the axial rigidity in the radial direction of the bearing. Also, since three balls are disposed, bearing losses due to elastic deformation of the balls can be reduced. Further, in the case of less inertia moment because of a rotation support arm reduced in size, the frictional force of the bearing can be decreased and it is possible to lessen the bad influences to the tracking control of frictional resonance generated due to the friction of the bearing.

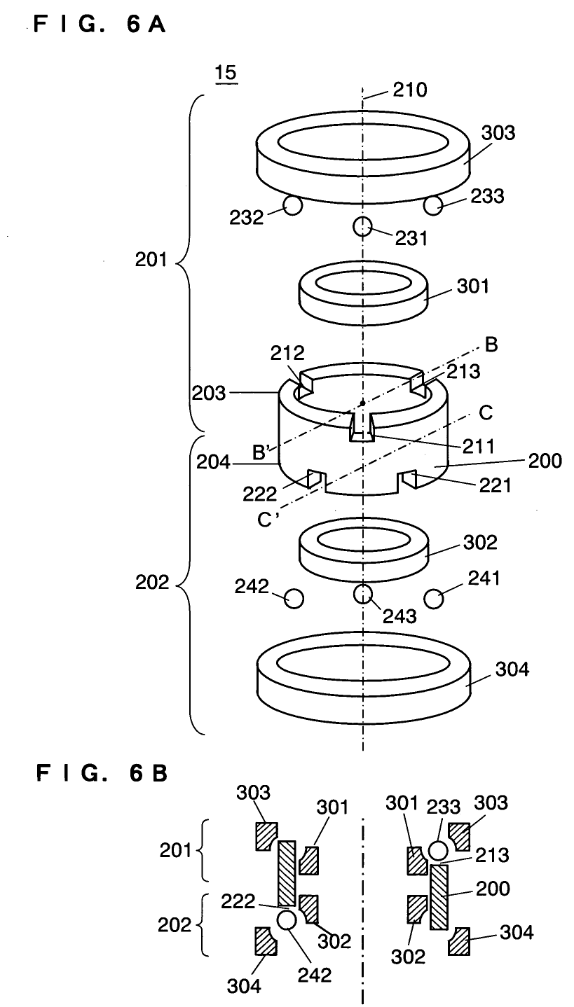

FIG. 6A shows an assembly flow of the bearing device 15 comprising the first bearing 201 and the second bearing 202.

FIG. 6B is a sectional view along B-B′ and C-C′ showing an example of a guide groove for regulating the movement of the ball in the vertical and horizontal directions.

As shown in FIG. 6A, the first bearing 201 and the second bearing 202 are arranged one upon another in the direction of rotary axis 210 of the bearing device 15. The first bearing 201 and the second bearing 202 includes a common cylindrical retainer 200. The retainer 200 is provided with grooves 211, 212 and 213 disposed, as an example, 120 degrees apart from each other at the outer periphery at one end 203 in the direction of rotary axis 210.

Also, the retainer 200 is provided with a plurality of grooves 221, 222 and 223 disposed 120 degrees apart from each other at the outer periphery of the other end 204 in the direction of rotary axis 210. The grooves 211, 212 and 213 disposed at one end 203 of the retainer 200 and the grooves 221, 222 and 223 disposed at the other end 204 are arranged so as to be positioned on a line extended toward the outer periphery from the rotary axis 210, that is, at an angle of 60 degrees in the radial direction of the retainer 200. The cylindrical retainer 200 is provided with balls 231, 232 and 233, balls 241, 242 and 243 respectively in its grooves 211, 212 and 213, grooves 221, 222 and 223.

Also, there are provided inner rings 301 and 302 which respectively support the inner sides of balls of the first bearing 201 and the second bearing 202. Also, there are provided outer rings 303 and 304 which respectively support the outer sides of balls of the first bearing 201 and the second bearing 202.

When assembling the first bearing 201, the inner ring 301 is fitted along the inner side at one end 203 of the retainer 200, then the balls 231, 232 and 233 are respectively placed in the grooves 211, 212 and 213 at one end 203 of the retainer 200, and finally the outer ring 303 is fitted along the outer side at one end 203 of the retainer 200.

When assembling the second bearing 202, the inner ring 301 is fitted along the inner side at the other end 204 of the retainer 200, then the balls 241, 242 and 243 are respectively placed in the grooves 221, 222 and 223 at the other end 204 of the retainer 200, and finally the outer ring 304 is fitted along the outer side at the other end 204 of the retainer 200.

FIG. 6B is a sectional view along B-B′ and C-C′ of the groove 213 and groove 222. It shows the positional relations of inner ring 301, groove 213, ball 233, and outer ring 303. The ball 233 is supported without pre-load by a groove 213 recessed at one end 203 of the retainer 200, a groove recessed at the outer side of inner ring 301, and a groove recessed at the inner side of outer ring 303. Also, the ball 242 is supported without pre-load by a groove 222 recessed at the other end 204 of the retainer 200, a groove recessed at the outer side of inner ring 302, and a groove recessed at the inner side of outer ring 304. The other balls (not shown) are similarly supported without pre-load in the positions of the corresponding grooves. The grooves recessed at the outer sides of inner rings 301 and 302 are preferable to be grooves along the outer periphery thereof whose section has a curvature that is a little larger than the curvature of the ball or spherically recessed grooves formed in positions corresponding to the spherical surfaces of individual balls. The former grooves are advantageous from the viewpoint of machining and assembling of the members.

Also, the grooves recessed at the inner side of outer rings 303 and 304 are preferable to be inner peripheral grooves whose section has a curvature a little larger than the spherical surface of the ball or spherical grooves formed at positions corresponding to the spherical surface of each ball. The former grooves are advantageous from the viewpoint of machining and assembling of the members.

In this way, since all the balls 231, 232, 233, 241, 242, and 243 are arranged without pre-load, the elastic deformation of balls and bearings and frictional losses of bearings can be minimized. As a result, with it applied to the support arm 16 which is small-sized, light-weight, and of low inertia, it is possible to obtain high-speed rotatory displacement that is great enough as against a low level of driving current. The purpose of cost reduction can be achieved by using six balls (three balls per bearing).

Also, since it is structurally possible to use the retainer 200 with one end and the other end in either position, the assembling efficiency can be increased. Also, since the inner rings 301 and 302 can be formed in same shape, the kinks of part materials can be reduced. Similarly, the outer rings 303 and 304 can be formed in same shape, and the kinds of parts can be reduced. These may contribute to the reduction of cost.

The bearing device 15 can be designed in that the outer shape is about 6.0φ as an example, the ball used for the ball bearing is about 0.8φ in outer diameter, and the length (height) in the rotary axial direction of the retainer is about 2 mm, and thereby, the operation is stabilized. Even in case of using stainless steel which is a material generally employed for the ball, retainer, inner ring, and outer ring, the bearing device 15 may realize more reliable operation as compared with conventional devices.

In the bearing of the present invention, the grooves formed in zigzag fashion at one end and the other end of the retainer form a stable triangle between them. Thus, the bearing may greatly reduce the axial deviation and frictional resonance of the rotary shaft.

Also, the elastic deformation of the bearing can be greatly reduced. Accordingly, rotary shaft deviation can be reduced by using less number of balls, and the bearing can be small-sized. Also, since the pre-load can be decreased, it is possible to lessen the influences due to variations of the ball shape. and ball diameter and to lower the starting torque and to reduce the elastic deformation load or rotational friction loss of the bearing. As a result, it is possible to realize a bearing which is small-sized, light-weight, low-noise, high-speed response, power-saving, and high-performance.

With bearings arranged at either end of the cylindrical retainer, the balls at either end thereof can be disposed in a fixed angular relation to each other at different angles as viewed in the axial direction, and therefore, in addition to the effects described above, it becomes extremely easy to assemble the bearing. Accordingly, it is possible to realize a bearing which may assure excellent productivity and low cost.

By using such a bearing, because of the effects as described above, it can be applied to a recording medium with a small outer diameter, and it is possible to realize a head support device and recording/reproducing device which are small-sized, light-weight, high-speed response, low-noise, low-cost, and high-performance.

By using such a bearing, even in case of a rotation support arm small-sized and lowered in inertia moment, it is free from non-linear saturation characteristic of the rotational angle, and the rotational angle of the arm can be sufficiently increased, and the restriction due to the frictional resonance of the bearing can be reduced.

Also, since it is structurally possible to use the retainer with one end and the other end in either position, the assembling efficiency can be increased. Also, the two inner rings can be formed in same shape. Similarly, the two outer rings can be formed in same shape, and the kinks of part materials can be reduced. Accordingly, it is possible to reduce the cost of the bearing.

What is claimed is:

1. A bearing device comprising a first bearing and a second bearing, wherein said first bearing and said second bearing are arranged one upon another in the axial direction of said bearing device, and said first bearing has a first retainer, and a plurality of first grooves are provided at the outer periphery of said first retainer, and said second bearing has a second retainer, and a plurality of second grooves are provided at the outer periphery of said second retainer, and said bearing device is configured in that balls are placed in said first grooves and said second grooves in such manner that a first segment connecting the center of said first retainer to said first groove does not overlap a second segment connecting the center of said second retainer to said second groove.

2. The bearing device of claim 1, wherein said first retainer and said second retainer are integrated.

3. The bearing device of claim 1, wherein when the number of said first grooves and said second grooves is N (N is 2 or larger integer) respectively, said first grooves and said second grooves are arranged at 360/N (degrees) to each other at the outer periphery of a cylindrical retainer, and the first segment connecting the center of said first retainer to the first groove does not overlap the second segment connecting the center of the second retainer to the second groove, and the first segment and the second segment are apart from each other at an angle of 360/(2N).

4. The bearing device of claim 3, wherein the number N of grooves disposed at the peripheries of one end and the other end in the axial direction of rotation of said retainer is N=3 respectively.

5. A bearing device comprising a first bearing and a second bearing, wherein said first bearing and said second bearing are arranged one upon another in the axial direction of said bearing device, and said first bearing has a first retainer, and a plurality of first grooves are provided at the outer periphery of said first retainer, and said second bearing has a second retainer, and a plurality of second grooves are provided at the outer periphery of said second retainer, and balls are placed in said first grooves and said second grooves in such manner that a first segment connecting the center of said first retainer to said first groove does not overlap a second segment connecting the center of said second retainer to said second groove, and an inner sleeve which supports an inner ring for balls of said first bearing and said second bearing and an outer sleeve which supports an outer ring for balls of said first bearing and said second bearing.

6. The bearing device of claim 5, wherein a groove recessed at the outer side of said inner ring is a curved recess whose section corresponding to the position of each ball has a curvature a little larger than the curvature of the ball, and a groove recessed at the inner side of said outer ring is a curved recess whose section corresponding to the position of each ball has a curvature a little larger than the curvature of the ball.

7. The bearing device of claim 5, wherein a groove recessed at the outer side of said inner ring is an outer peripheral groove whose section has a curvature a little larger than the curvature of the ball, and a groove recessed at the inner side of said outer ring is an inner peripheral groove whose section has a curvature a little larger than the curvature of the ball.

8. A head support device, wherein a first bearing and a second bearing are arranged one upon another in the axial direction of the bearing device, and said first bearing has a first retainer, and a plurality of first grooves are provided at the outer periphery of said first retainer, and said second bearing has a second retainer, and a plurality of second grooves are provided at the outer periphery of said second retainer, and balls are placed in said first grooves and said second grooves in such manner that a first segment connecting the center of said first retainer to the first groove does not overlap a second segment connecting the center of said second retainer to the second groove, and said bearing device is connected to a support arm having a slider and a voice coil.

9. The head support device of claim 8, wherein a slider and a voice coil are arranged at positions apart from each other with the bearing device therebetween.

10. A recording/reproducing device comprising a recording medium and a rotation driving means for rotationally driving said recording medium, a support arm mounted with a slider and a voice coil, which has a head for reading information stored in said recording medium, and a head support device for driving said support arm, wherein said head support device comprises a bearing device provided with a first bearing and a second bearing, and said first bearing and said second bearing are arranged one upon another in a direction axial to said bearing device, and said first bearing has a first retainer, and a plurality of first grooves are provided at the outer periphery of said first retainer, and said second bearing has a second retainer, and a plurality of second grooves are provided at the outer periphery of said second retainer, and balls are placed in said first grooves and said second grooves in such manner that a first segment connecting the center of said first retainer to said first groove does not overlap a second segment connecting the center of said second retainer to said second groove, and said bearing device is connected to a support arm having a slider and a voice coil.
